(19) United States
(12) Patent Application Publication
(10) Pub. No.: US 2025/0097885 A1
(43) Pub. Date: Mar. 20, 2025

(54) METHODS AND APPARATUS FOR SENSING-ASSISTED DOPPLER COMPENSATION

(71) Applicant: Huawei Technologies Co., Ltd., Shenzhen (CN)

(72) Inventors: Alireza Bayesteh, Brossard (CA); Huang Huang, Shenzhen (CN); Xiaoyan Bi, Kanata (CA); Jianglei Ma, Kanata (CA)

(21) Appl. No.: 18/941,772

(22) Filed: Nov. 8, 2024

Related U.S. Application Data
(63) Continuation of application No. PCT/CN2022/092038, filed on May 10, 2022.

(51) Int. Cl. H04W 64/00

(52) U.S. Cl. CPC H04W 64/00

(57) ABSTRACT

Aspects of the present application relate to sensing-based, mobility-aware waveform adaptation. A transmitting device may estimate a velocity vector for a mobile device. The velocity vector estimate may be based on measurements made at the mobile device and fed back to the transmitting device or based on measurements made at other devices in the environment and provided to the transmitting device. The transmitting device may, based on the estimate of the velocity vector, obtain a Doppler variable estimate for a signal path between the transmitting device and the mobile device. The transmitting device may then adapt a to-be-transmitted waveform based on the Doppler variable estimate for the signal path and then transmit the adapted waveform. Occasionally, the transmitting device may obtain updates to parameters that describe the location and mobility of the mobile device. On the basis of the updates, the transmitting device may update the waveform adaptation.

### CROSS-REFERENCE TO RELATED APPLICATION

This application is a continuation of International Application No. PCT/CN2022/092038, filed on May 10, 2022, the disclosure of which is hereby incorporated by reference in its entirety.

### TECHNICAL FIELD

The present disclosure relates, generally, to wireless communication and, in particular embodiments, to sensing-assisted Doppler compensation.

### BACKGROUND

User Equipment (UE) position information can be used in cellular communication networks to improve various performance metrics for the network. Such performance metrics may, for example, include capacity, agility, reliability and efficiency. The improvement may be achieved when elements of the network exploit the position, the behavior, the mobility pattern, etc., of the UE in the context of a priori information describing a wireless environment in which the UE is operating.

Cyclic Prefix Orthogonal Frequency Division Multiplexing (CP-OFDM) has been a dominant waveform in Long-Term Evolution (LTE) cellular systems and new radio, optionally with Discrete Fourier Transform (DFT) precoding to control Peak-to-Average Power Ratio (PAPR). However, CP-OFDM suffers from performance degradation for highly time-selective channels. Such performance degradation may occur, in particular, for high mobility users. The mobility of the high mobility users may introduce a relatively large Doppler variable. The relatively large Doppler variable may result in a loss of orthogonality between the subcarriers. The loss of orthogonality may be held responsible for the overall performance degradation. Several waveforms have been proposed to address the loss of orthogonality issue. One proposed waveform is obtained by modulating, in the fractional domain, a waveform formed by chirp-modulating OFDM. However, the proposed waveforms may be shown to perform well only in high-mobility scenarios. Furthermore, the proposed waveforms may be shown to have worse performance than traditional OFDM for UEs in more typical mobility scenarios. Indeed, it may be shown that the use of the proposed fractional domain-modulated waveforms leads to excessive complexity in receiver design.

### SUMMARY

Aspects of the present application relate to sensing-based, mobility-aware waveform adaptation. A transmitting device may obtain a velocity vector for a mobile device. The velocity vector estimate may be based on measurements made at the mobile device and fed back to the transmitting device or based on measurements made at other devices in the environment and provided to the transmitting device. The transmitting device may, based on the estimate of the velocity vector, obtain a Doppler variable estimate for a signal path between the transmitting device and the mobile device. A Doppler variable may include a Doppler mean, indicating a mean value of a plurality of Doppler shift values, and a Doppler spread, indicating a range of Doppler shift variations. Helpful to the task of obtaining the Doppler variable estimate may be information regarding an angle of arrival at the mobile device for signals that follow the signal path. Such angle of arrival information may be received from the mobile device or determined based on UE position information. The transmitting device may then adapt a to-be-transmitted waveform based on the Doppler variable estimate for the signal path and then transmit the adapted waveform. Occasionally, the transmitting device may obtain updates to parameters that describe the location and mobility of the mobile device. On the basis of the updates, the transmitting device may update the waveform adaptation.

It may be considered that the main problem with the aforementioned proposed waveforms is the lack of adaptability to UE mobility.

Aspects of the present application relate to achieving improvements to communication performance by compensating for a Doppler variable that may be present for high-mobility UEs. The compensation may take the form of Doppler variable estimation and pre-compensation. The Doppler variable estimation may be based on UE location and UE mobility. Furthermore, by reusing uplink transmission resources, a reduction in downlink sensing resource overhead may be realized. Advantageously, waveforms may be adapted to varying UE mobility without necessitating excessive receiver complexity.

According to an aspect of the present disclosure, there is provided a method, carried out at a transmitting device, of Doppler compensation for a transmission of waveform time samples. The method includes obtaining, at the transmitting device, an estimate of a velocity vector for the mobile device. The method further includes obtaining, at the transmitting device and based on the estimate of the velocity vector, an estimate of a Doppler variable for a signal path between the transmitting device and the mobile device. The method further includes obtaining, at the transmitting device and based on the estimate of the Doppler variable for the signal path, an adapted waveform. The method further includes transmitting, from the transmitting device, a signal according to the adapted waveform.

In an optional embodiment of the preceding aspect, the obtaining the estimate of the velocity vector comprises basing the estimate of the velocity vector on information received from a sensing device.

In an embodiment the method further comprises transmitting, to the sensing device, an indication of a configuration for a sensing reference signal. Optionally, the configuration comprises an indication of an approximate position of the mobile device. Optionally, the configuration comprises an indication of an initial direction in which to point the sensing reference signal. Optionally, the configuration comprises an indication of time resources for the sensing reference signal and an indication of frequency resources for the sensing reference signal. Optionally, the configuration comprises an indication of a waveform type for the sensing reference signal. Optionally, the configuration comprises an indication of a numerology for the sensing reference signal. Optionally, the configuration comprises an indication of a mapping function to be used when generating a time domain signal on the basis of a sensing profile identification. Optionally, the configuration comprises an indication of a sensing identification of the mobile device, wherein the sensing identification is different from an identification that is associated with the mobile device for identifying the mobile device in a data communication context.

In an optional embodiment, the sensing device comprises a device that is distinct from the mobile device.

In an optional embodiment, the velocity vector comprises a plurality of velocity values associated with a corresponding plurality of orthogonal directions in a global coordinate system.

In an optional embodiment, the velocity vector comprises a scalar velocity magnitude, an azimuth angle and a zenith angle.

In an optional embodiment, the method further comprises obtaining, at the transmitting device, an estimate of a position vector for the mobile device, and wherein the obtaining the estimate of the Doppler variable is further based on the position vector. Optionally, the position vector comprises a plurality of values associated with a corresponding plurality of orthogonal directions in a global coordinate system.

According to aspects of the present disclosure, there is provided a transmitting device comprising a processor configured to cause the device to perform any of the preceding methods, and a computer-readable storage medium comprising instructions which, when executed by a computer, cause the computer to carry out any of the preceding methods.

According to an aspect of the present disclosure, there is provided a method, carried out at a transmitting device, of Doppler compensation for a transmission of waveform time samples a mobile device. The method includes receiving an uplink signal, processing, at the transmitting device, the uplink signal to obtain an estimate of an uplink Doppler variable for a signal path between the mobile device and the transmitting device, obtaining, at the transmitting device and based on the estimate of the uplink Doppler variable for the signal path, an adapted waveform and transmitting, from the transmitting device, the adapted waveform.

According to aspects of the present disclosure, there is provided a transmitting device comprising a processor configured to cause the device to perform any of the preceding methods, and a computer-readable storage medium comprising instructions which, when executed by a computer, cause the computer to carry out any of the preceding methods.

According to an aspect of the present disclosure, there is provided a method of facilitating Doppler compensation for a transmission of waveform time samples. The method includes receiving, at a mobile device, a sensing reference signal. The method further includes processing, at the mobile device, the sensing reference signal to obtain an estimate of a velocity vector for the mobile device. The method further includes transmitting, from the mobile device to a transmitting device, feedback. The feedback includes an indication of the estimate of the velocity vector, thereby allowing the transmitting device to obtain, based on the estimate of the velocity vector, an estimate of a Doppler variable for a signal path between the transmitting device and the mobile device and obtain, based on the estimate of the Doppler variable for the signal path, an adapted waveform. The method further includes receiving, at the mobile device, a signal according to the adapted waveform.

In an optional embodiment of the preceding aspect, the method further comprises, before the receiving the sensing reference signal, receiving an indication of a configuration for the sensing reference signal. Optionally, the configuration comprises an indication of time resources for the sensing reference signal and an indication of frequency resources for the sensing reference signal. Optionally, the configuration comprises an indication of a waveform type for the sensing reference signal. Optionally, the configuration comprises an indication of a numerology for the sensing reference signal. Optionally, the configuration comprises an indication of a mapping function to be used when generating a time domain signal on the basis of a sensing profile identification.

In an optional embodiment, the method further comprises receiving, from the transmitting device, an indication of a Doppler pre-compensation value, the Doppler pre-compensation value characterizing the adapted waveform.

In an optional embodiment, the velocity vector comprises a plurality of velocity values associated with a corresponding plurality of orthogonal directions in a global coordinate system.

In an optional embodiment, the velocity vector comprises a scalar velocity magnitude, an azimuth angle and a zenith angle.

According to aspects of the present disclosure, there is provided a mobile device comprising a processor configured to cause the device to perform any of the preceding methods, and a computer-readable storage medium comprising instructions which, when executed by a computer, cause the computer to carry out any of the preceding methods.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 illustrates, in a schematic diagram, a communication system in which embodiments of the disclosure may occur, the communication system includes multiple example electronic devices and multiple example transmit receive points along with various networks;

FIG. 2 illustrates, in a block diagram, the communication system of FIG. 1, the communication system includes multiple example electronic devices, an example terrestrial transmit receive point and an example non-terrestrial transmit receive point along with various networks;

FIG. 3 illustrates, as a block diagram, elements of an example electronic device of FIG. 2, elements of an example terrestrial transmit receive point of FIG. 2 and elements of an example non-terrestrial transmit receive point of FIG. 2, in accordance with aspects of the present application;

FIG. 4 illustrates, as a block diagram, various modules that may be included in an example electronic device, an example terrestrial transmit receive point and an example non-terrestrial transmit receive point, in accordance with aspects of the present application;

FIG. 5 illustrates, as a block diagram, a sensing management function, in accordance with aspects of the present application;

FIG. 6 illustrates an environment including an example terrestrial transmit receive point, an example electronic device, a scatterer and a reflector;

FIG. 7 illustrates a signal flow diagram for an exchange of signals between the terrestrial transmit receive point of FIG. 6 and the example electronic device of FIG. 6 during Doppler compensation, in accordance with aspects of the present application;

FIG. 8 illustrates a time line with two consecutive sensing stages interposed by communicating and updating;

FIG. 9 illustrates the environment of FIG. 6 with the example electronic device in motion;

FIG. 10 illustrates the environment of FIG. 6 with the example electronic device in motion;

FIG. 11 illustrates an environment including an example terrestrial transmit receive point, an example electronic device, a reflector and two sensing nodes;

FIG. 12 illustrates a signal flow diagram for an exchange of signals between the terrestrial transmit receive point of FIG. 11, the example electronic device of FIG. 11 and one of the sensing nodes of FIG. 11 during Doppler compensation, in accordance with aspects of the present application;

FIG. 13 illustrates an environment including an example terrestrial transmit receive point, an example electronic device and a reflector;

FIG. 14 illustrates example steps in a method of uplink-based Doppler determination and pre-compensation for the example terrestrial transmit receive point of FIG. 13, in accordance with aspects of the present application;

FIG. 15A illustrates a scenario wherein an example electronic device receives a signal from an example terrestrial transmit receive point over multiple paths; and

FIG. 15B illustrates a scenario wherein an example electronic device receives a signal from an example terrestrial transmit receive point over multiple paths.

### DETAILED DESCRIPTION OF ILLUSTRATIVE EMBODIMENTS

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

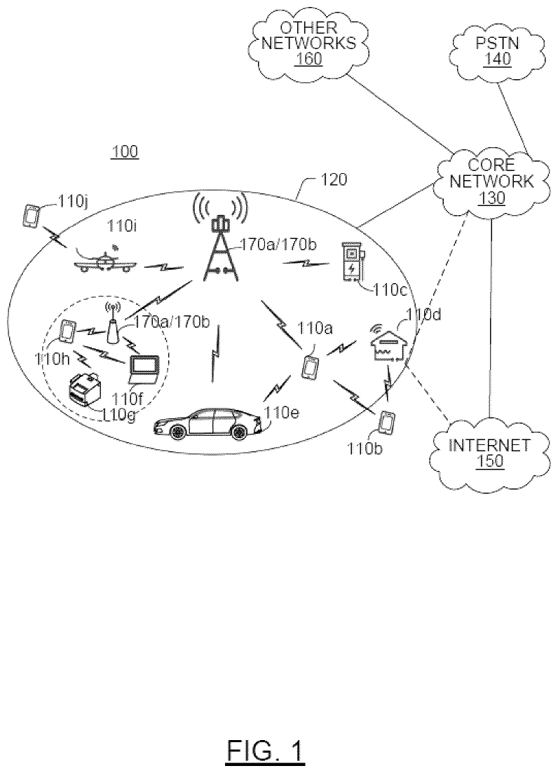

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

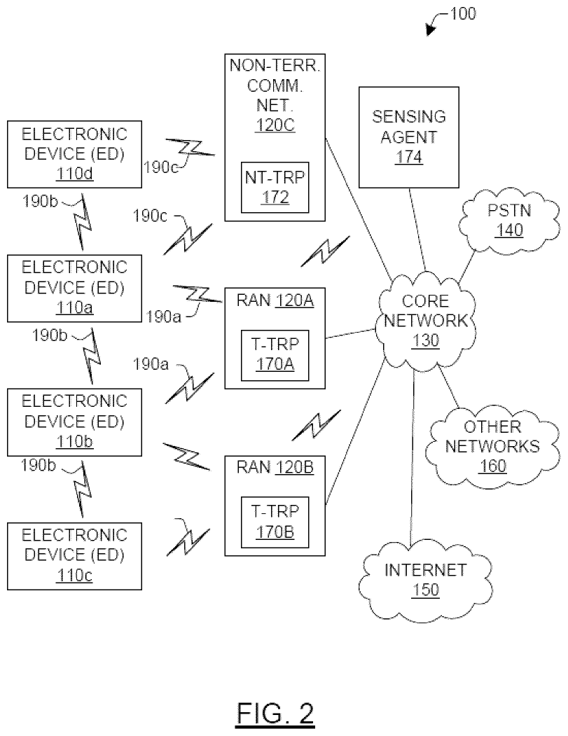

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), single-carrier FDMA (SC-FDMA) or Discrete Fourier Transform spread OFDMA (DFT-s-OFDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

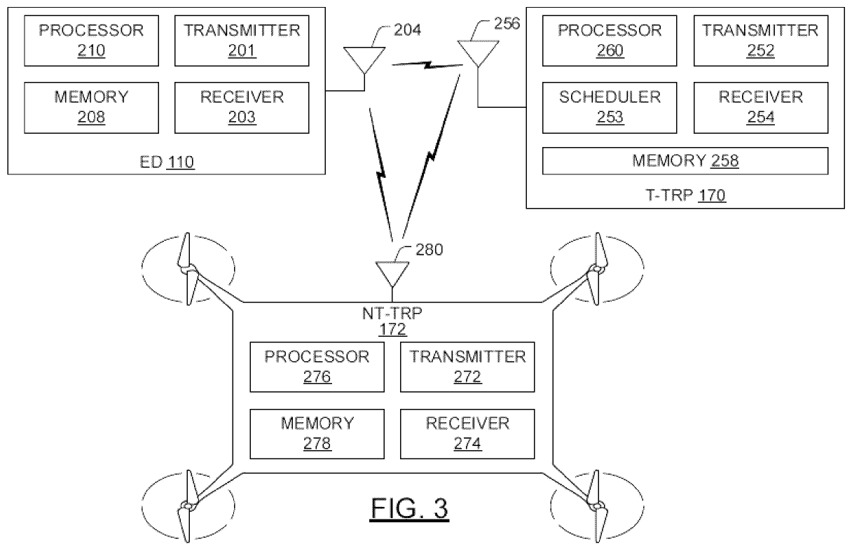

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a watch, head mounted equipment, a pair of glasses, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. A panel is a unit of an antenna group, or antenna array, or antenna sub-array, which unit can control a Tx beam or a Rx beam independently. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

As illustrated in FIG. 3, the T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output, “MIMO,” precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a CPU, a GPU or an ASIC.

Notably, the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a CPU, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

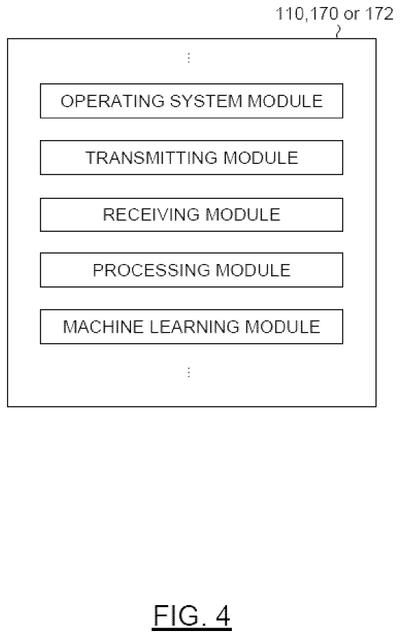

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g., data) over a wireless communications link. The wireless communications link may support a link between a radio access network and user equipment (e.g., a “Uu” link), and/or the wireless communications link may support a link between device and device, such as between two user equipments (e.g., a “sidelink”), and/or the wireless communications link may support a link between a non-terrestrial (NT)-communication network and user equipment (UE). The following are some examples for the above components.

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Discrete Fourier Transform spread OFDM (DFT-s-OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform and low Peak to Average Power Ratio Waveform (low PAPR WF).

A frame structure component may specify a configuration of a frame or group of frames. The frame structure component may indicate one or more of a time, frequency, pilot signature, code or other parameter of the frame or group of frames. More details of frame structure will be discussed hereinafter.

A multiple access scheme component may specify multiple access technique options, including technologies defining how communicating devices share a common physical channel, such as: TDMA; FDMA; CDMA; SDMA; OFDMA; SC-FDMA; Low Density Signature Multicarrier CDMA (LDS-MC-CDMA); Non-Orthogonal Multiple Access (NOMA); Pattern Division Multiple Access (PDMA); Lattice Partition Multiple Access (LPMA); Resource Spread Multiple Access (RSMA); and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources; and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all” concept. For example, it may be that the components within the air interface cannot be changed or adapted once the air interface is defined. In some implementations, only limited parameters or modes of an air interface, such as a cyclic prefix (CP) length or a MIMO mode, can be configured. In some embodiments, an air interface design may provide a unified or flexible framework to support frequencies below known 6 GHz bands and frequencies beyond the 6 GHz bands (e.g., mmWave bands) for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain and a frequency domain self-contained design may support more flexible RAN slicing through channel resource sharing between different services in both frequency and time.

A frame structure is a feature of the wireless communication physical layer that defines a time domain signal transmission structure to, e.g., allow for timing reference and timing alignment of basic time domain transmission units. Wireless communication between communicating devices may occur on time-frequency resources governed by a frame structure. The frame structure may, sometimes, instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g., uplink vs. downlink) occur in different frequency bands. TDD communication is when transmissions in different directions (e.g., uplink vs. downlink) occur over different time durations. FD communication is when transmission and reception occurs on the same time-frequency resource, i.e., a device can both transmit and receive on the same frequency resource contemporaneously.

One example of a frame structure is a frame structure, specified for use in the known long-term evolution (LTE) cellular systems, having the following specifications: each frame is 10 ms in duration; each frame has 10 subframes, which subframes are each 1 ms in duration; each subframe includes two slots, each of which slots is 0.5 ms in duration; each slot is for the transmission of seven OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD is specified as the integer time of OFDM symbol duration.

Another example of a frame structure is a frame structure, specified for use in the known new radio (NR) cellular systems, having the following specifications: multiple subcarrier spacings are supported, each subcarrier spacing corresponding to a respective numerology; the frame structure depends on the numerology but, in any case, the frame length is set at 10 ms and each frame consists of ten subframes, each subframe of 1 ms duration; a slot is defined as 14 OFDM symbols; and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing, the slot length is 1 ms and, for 30 kHz subcarrier spacing, the slot length is 0.5 ms. The NR frame structure may have more flexibility than the LTE frame structure.

Another example of a frame structure is, e.g., for use in a 6G network or a later network. In a flexible frame structure, a symbol block may be defined to have a duration that is the minimum duration of time that may be scheduled in the flexible frame structure. A symbol block may be a unit of transmission having an optional redundancy portion (e.g., CP portion) and an information (e.g., data) portion. An OFDM symbol is an example of a symbol block. A symbol block may alternatively be called a symbol. Embodiments of flexible frame structures include different parameters that may be configurable, e.g., frame length, subframe length, symbol block length, etc. A non-exhaustive list of possible configurable parameters, in some embodiments of a flexible frame structure, includes: frame length; subframe duration; slot configuration; subcarrier spacing (SCS); flexible transmission duration of basic transmission unit; and flexible switch gap.

The frame length need not be limited to 10 ms and the frame length may be configurable and change over time. In some embodiments, each frame includes one or multiple downlink synchronization channels and/or one or multiple downlink broadcast channels and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set to 5 ms for autonomous vehicle applications. As another example, smart meters on houses may not require fast initial access, in which case the frame length may be set as 20 ms for smart meter applications.

A subframe might or might not be defined in the flexible frame structure, depending upon the implementation. For example, a frame may be defined to include slots, but no subframes. In frames in which a subframe is defined, e.g., for time domain alignment, the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.

A slot might or might not be defined in the flexible frame structure, depending upon the implementation. In frames in which a slot is defined, then the definition of a slot (e.g., in time duration and/or in number of symbol blocks) may be configurable. In one embodiment, the slot configuration is common to all UEs 110 or a group of UEs 110. For this case, the slot configuration information may be transmitted to the UEs 110 in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration may be transmitted independently from the frame configuration signaling and/or subframe configuration signaling. In general, the slot configuration may be system common, base station common, UE group common or UE specific.

The SCS may range from 15 KHz to 480 KHz. The SCS may vary with the frequency of the spectrum and/or maximum UE speed to minimize the impact of Doppler variable and phase noise. In some examples, there may be separate transmission and reception frames and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g., if more flexible symbol durations are implemented using inverse discrete Fourier transform (IDFT) instead of fast Fourier transform (FFT). Additional examples of frame structures can be used with different SCSs.

The basic transmission unit may be a symbol block (alternatively called a symbol), which, in general, includes a redundancy portion (referred to as the CP) and an information (e.g., data) portion. In some embodiments, the CP may be omitted from the symbol block. The CP length may be flexible and configurable. The CP length may be fixed within a frame or flexible within a frame and the CP length may possibly change from one frame to another, or from one group of frames to another group of frames, or from one subframe to another subframe, or from one slot to another slot, or dynamically from one scheduling to another scheduling. The information (e.g., data) portion may be flexible and configurable. Another possible parameter relating to a symbol block that may be defined is ratio of CP duration to information (e.g., data) duration. In some embodiments, the symbol block length may be adjusted according to: a channel condition (e.g., multi-path delay, Doppler variable); and/or a latency requirement; and/or an available time duration. As another example, a symbol block length may be adjusted to fit an available time duration in the frame.

A frame may include both a downlink portion, for downlink transmissions from a base station 170, and an uplink portion, for uplink transmissions from the UEs 110. A gap may be present between each uplink and downlink portion, which gap is referred to as a switching gap. The switching gap length (duration) may be configurable. A switching gap duration may be fixed within a frame or flexible within a frame and a switching gap duration may possibly change from one frame to another, or from one group of frames to another group of frames, or from one subframe to another subframe, or from one slot to another slot, or dynamically from one scheduling to another scheduling.

A device, such as a base station 170, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g., the center frequency, the lowest frequency or the highest frequency of the carrier. A carrier may be on a licensed spectrum or an unlicensed spectrum. Wireless communication with the device may also, or instead, occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and, optionally, one or multiple uplink resources. A cell may include one or multiple uplink resources and, optionally, one or multiple downlink resources. A cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may, instead or additionally, include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g., a carrier may have a bandwidth of 20 MHz and consist of one BWP or a carrier may have a bandwidth of 80 MHz and consist of two adjacent contiguous BWPs, etc. In other embodiments, a BWP may have one or more carriers, e.g., a BWP may have a bandwidth of 40 MHz and consist of two adjacent contiguous carriers, where each carrier has a bandwidth of 20 MHz. In some embodiments, a BWP may comprise non-contiguous spectrum resources, which consists of multiple non-contiguous multiple carriers, where the first carrier of the non-contiguous multiple carriers may be in the mmW band, the second carrier may be in a low band (such as the 2 GHz band), the third carrier (if it exists) may be in THz band and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage, β/2, of the total mean transmitted power, for example, the value of β/2 is taken as 0.5%.

The carrier, the BWP or the occupied bandwidth may be signaled by a network device (e.g., by a base station 170) dynamically, e.g., in physical layer control signaling such as the known downlink control channel (DCI), or semi-statically, e.g., in radio resource control (RRC) signaling or in signaling in the medium access control (MAC) layer, or be predefined based on the application scenario; or be determined by the UE 110 as a function of other parameters that are known by the UE 110, or may be fixed, e.g., by a standard.

UE position information may be used in cellular communication networks to improve various performance metrics for the network. Such performance metrics may, for example, include capacity, agility and efficiency. The improvement may be achieved when elements of the network exploit the position, the behavior, the mobility pattern, etc., of the UE in the context of a priori information describing a wireless environment in which the UE is operating.

A sensing system may be used to help gather UE pose information, including UE location in a global coordinate system, UE velocity and direction of movement in the global coordinate system, orientation information and the information about the wireless environment. “Location” is also known as “position” and these two terms may be used interchangeably herein. Examples of well-known sensing systems include RADAR (Radio Detection and Ranging) and LIDAR (Light Detection and Ranging). While the sensing system is typically separate from the communication system, it could be advantageous to gather the information using an integrated system, which reduces the hardware (and cost) in the system as well as the time, frequency or spatial resources needed to perform both functionalities. However, using the communication system hardware to perform sensing of UE pose and environment information is a highly challenging and open problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems.

Any or all of the EDs 110 and BS 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications and are, instead, dedicated to sensing. The sensing agent 174 is an example of a sensing node that is dedicated to sensing. Unlike the EDs 110 and BS 170, the sensing agent 174 does not transmit or receive communication signals. However, the sensing agent 174 may communicate configuration information, sensing information, signaling information, or other information within the communication system 100. In some cases, a plurality of sensing agents 174 may be implemented and may communicate with each other to jointly perform a sensing task. The sensing agent 174 may be in communication with the core network 130 to communicate information with the rest of the communication system 100. By way of example, the sensing agent 174 may determine the location of the ED 110a, and transmit this information to the base station 170a via the core network 130. Although only one sensing agent 174 is shown in FIG. 2, any number of sensing agents may be implemented in the communication system 100. In some embodiments, one or more sensing agents may be implemented at one or more of the RANS 120.

A sensing node may combine sensing-based techniques with reference signal-based techniques to enhance UE pose determination. This type of sensing node may also be known as a node that implements a sensing management function (SMF). In some networks, the SMF may also be known as a node that implements a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 260. In this scenario, the sensing node may provide the sensing information to SMF for processing.

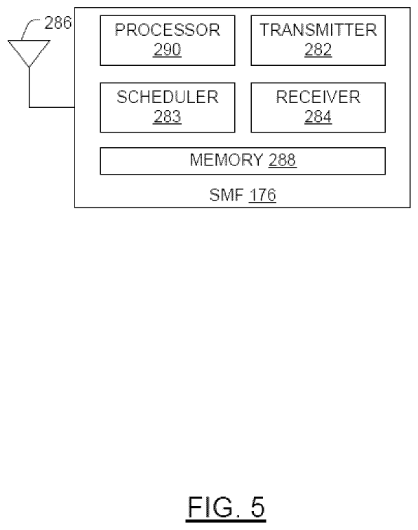

As shown in FIG. 5, an SMF 176, when implemented as a physically independent entity, includes at least one processor 290, at least one transmitter 282, at least one receiver 284, one or more antennas 286 and at least one memory 288. A transceiver, not shown, may be used instead of the transmitter 282 and the receiver 284. A scheduler 283 may be coupled to the processor 290. The scheduler 283 may be included within or operated separately from the SMF 176. The processor 290 implements various processing operations of the SMF 176, such as signal coding, data processing, power control, input/output processing or any other functionality. The processor 290 can also be configured to implement some or all of the functionality and/or embodiments described in more detail above. Each processor 290 includes any suitable processing or computing device configured to perform one or more operations. Each processor 290 could, for example, include a microprocessor, microcontroller, digital signal processor, field programmable gate array or application specific integrated circuit.

A reference signal-based pose determination technique belongs to an “active” pose estimation paradigm. In an active pose estimation paradigm, the enquirer of pose information (e.g., the UE 110) takes part in process of determining the pose of the enquirer. The enquirer may transmit or receive and process (or both transmit and receive/process) a signal specific to pose determination process. Positioning techniques based on a global navigation satellite system (GNSS) such as the known Global Positioning System (GPS) are other examples of the active pose estimation paradigm. Various positioning technologies are also known in NR systems and in LTE systems.

In contrast, a sensing technique, based on radar for example, may be considered as belonging to a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining UE channel sub-space information, which is particularly useful for UE channel reconstruction at the sensing node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-side. Therefore, the combination of sensing-based techniques and reference signal-based techniques may enable the UE channel reconstruction with much less overhead as compared to traditional methods. Sub-space information can also facilitate sub-space-based sensing to reduce sensing complexity and improve sensing accuracy.

In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal and a second set of channels may be used to transmit a communications signal. In some embodiments, each channel in the first set of channels and each channel in the second set of channels is a logical channel, a transport channel or a physical channel.

At the physical layer, communication and sensing may be performed via separate physical channels. For example, a first physical downlink shared channel PDSCH-C is defined for data communication, while a second physical downlink shared channel PDSCH-S is defined for sensing. Similarly, separate physical uplink shared channels (PUSCH), PUSCH-C and PUSCH-S, could be defined for uplink communication and sensing.

In another example, the same PDSCH and PUSCH could be also used for both communication and sensing, with separate logical layer channels and/or transport layer channels defined for communication and sensing. Note also that control channel(s) and data channel(s) for sensing can have the same or different channel structure (format), occupy same or different frequency bands or bandwidth parts.

In a further example, a common physical downlink control channel (PDCCH) and a common physical uplink control channel (PUCCH) may be used to carry control information for both sensing and communication. Alternatively, separate physical layer control channels may be used to carry separate control information for communication and sensing. For example, PUCCH-S and PUCCH-C could be used for uplink control for sensing and communication respectively and PDCCH-S and PDCCH-C for downlink control for sensing and communication respectively.

Different combinations of shared and dedicated channels for sensing and communication, at each of the physical, transport, and logical layers, are possible.

The term RADAR originates from the phrase Radio Detection and Ranging; however, expressions with different forms of capitalization (e.g., Radar and radar) are equally valid and now more common. Radar is typically used for detecting a presence and a location of an object. A radar system radiates radio frequency energy and receives echoes of the energy reflected from one or more targets. The system determines the pose of a given target based on the echoes returned from the given target. The radiated energy can be in the form of an energy pulse or a continuous wave, which can be expressed or defined by a particular waveform. Examples of waveforms used in radar include frequency modulated continuous wave (FMCW) and ultra-wideband (UWB) waveforms.

Radar systems can be monostatic, bi-static or multi-static. In a monostatic radar system, the radar signal transmitter and receiver are co-located, such as being integrated in a transceiver. In a bi-static radar system, the transmitter and receiver are spatially separated, and the distance of separation is comparable to, or larger than, the expected target distance (often referred to as the range). In a multi-static radar system, two or more radar components are spatially diverse but with a shared area of coverage. A multi-static radar is also referred to as a multisite or netted radar.

A terrestrial communication system may also be referred to as a land-based or ground-based communication system, although a terrestrial communication system can also, or instead, be implemented on or in water. The non-terrestrial communication system may bridge coverage gaps in underserved areas by extending the coverage of cellular networks through the use of non-terrestrial nodes, which will be key to establishing global, seamless coverage and providing mobile broadband services to unserved/underserved regions. In the current case, it is hardly possible to implement terrestrial access-points/base-stations infrastructure in areas like oceans, mountains, forests, or other remote areas.

Terrestrial radar applications encounter challenges such as multipath propagation and shadowing impairments. Another challenge is the problem of identifiability because terrestrial targets have similar physical attributes. Integrating sensing into a communication system is likely to suffer from these same challenges, and more.

Communication nodes can be either half-duplex or full-duplex. A half-duplex node cannot both transmit and receive using the same physical resources (time, frequency, etc.); conversely, a full-duplex node can transmit and receive using the same physical resources. Existing commercial wireless communications networks are all half-duplex. Even if full-duplex communications networks become practical in the future, it is expected that at least some of the nodes in the network will still be half-duplex nodes because half-duplex devices are less complex, and have lower cost and lower power consumption. In particular, full-duplex implementation is more challenging at higher frequencies (e.g., in millimeter wave bands) and very challenging for small and low-cost devices, such as femtocell base stations and UEs.

The limitation of half-duplex nodes in the communications network presents further challenges toward integrating sensing and communications into the devices and systems of the communications network. For example, both half-duplex and full-duplex nodes can perform bi-static or multi-static sensing, but monostatic sensing typically requires the sensing node have full-duplex capability. A half-duplex node may perform monostatic sensing with certain limitations, such as in a pulsed radar with a specific duty cycle and ranging capability.

Properties of a sensing signal, or a signal used for both sensing and communication, include the waveform of the signal and the frame structure of the signal. The frame structure defines the time-domain boundaries of the signal. The waveform describes the shape of the signal as a function of time and frequency. Examples of waveforms that can be used for a sensing signal include ultra-wide band (UWB) pulse, Frequency-Modulated Continuous Wave (FMCW) or “chirp”, orthogonal frequency-division multiplexing (OFDM), cyclic prefix (CP)-OFDM, and Discrete Fourier Transform spread (DFT-s)-OFDM.

In an embodiment, the sensing signal is a linear chirp signal with bandwidth B and time duration T. Such a linear chirp signal is generally known from its use in FMCW radar systems. A linear chirp signal is defined by an increase in frequency from an initial frequency, f_{chirp0}, at an initial time, t_{chirp0}, to a final frequency, f_{chirp1}, at a final time, t_{chirp1} where the relation between the frequency (f) and time (t) can be expressed as a linear relation of

$$f - {f}_{chirp 0} = α ( t - {t}_{chirp 0} ) ,$$

$$where$$

$$α = \frac{{f}_{chirp 1} - {f}_{chirp 0}}{{t}_{chirp 1} - {t}_{chirp 0}}$$

is defined as the chirp slope. The bandwidth of the linear chirp signal may be defined as B=f_{chirp1}−f_{chirp0} and the time duration of the linear chirp signal may be defined as T=t_{chirp1}−t_{chirp0}. Such linear chirp signal can be presented as e^{jπat}^{²} in the baseband representation.

Precoding, as used herein, may refer to any coding operation(s) or modulation(s) that transform an input signal into an output signal. Precoding may be performed in different domains and typically transforms the input signal in a first domain to an output signal in a second domain. Precoding may include linear operations.

The terrestrial communication system may be a wireless communications system using 5G technology and/or later generation wireless technology (e.g., 6G or later). In some examples, the terrestrial communication system may also accommodate some legacy wireless technologies (e.g., 3G or 4G wireless technology). The non-terrestrial communication system may be a communications system using satellite constellations, like conventional Geo-Stationary Orbit (GEO) satellites, which utilize broadcast public/popular contents to a local server. The non-terrestrial communication system may be a communications system using low earth orbit (LEO) satellites, which are known to establish a better balance between large coverage area and propagation path-loss/delay. The non-terrestrial communication system may be a communications system using stabilized satellites in very low earth orbits (VLEO) technologies, thereby substantially reducing the costs for launching satellites to lower orbits. The non-terrestrial communication system may be a communications system using high altitude platforms (HAPs), which are known to provide a low path-loss air interface for the users with limited power budget. The non-terrestrial communication system may be a communications system using Unmanned Aerial Vehicles (UAVs) (or unmanned aerial system, “UAS”) achieving a dense deployment, since their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs may be coupled to integrate satellite communications to cellular networks. Emerging 3D vertical networks consist of many moving (other than geostationary satellites) and high altitude access points such as UAVs, HAPs and VLEOs.

MIMO technology allows an antenna array of multiple antennas to perform signal transmissions and receptions to meet high transmission rate requirements. The ED 110 and the T-TRP 170 and/or the NT-TRP may use MIMO to communicate using wireless resource blocks. MIMO utilizes multiple antennas at the transmitter to transmit wireless resource blocks over parallel wireless signals. It follows that multiple antennas may be utilized at the receiver. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the T-TRP 170 and/or the NT-TRP 172 configured with a large number of antennas has gained wide attention from academia and industry. In the large-scale MIMO system, the T-TRP 170, and/or the NT-TRP 172, is generally configured with more than ten antenna units (see antennas 256 and antennas 280 in FIG. 3). The T-TRP 170, and/or the NT-TRP 172, is generally operable to serve dozens (such as 40) of EDs 110. A large number of antenna units of the T-TRP 170 and the NT-TRP 172 can greatly increase the degree of spatial freedom of wireless communication, greatly improve the transmission rate, spectral efficiency and power efficiency, and, to a large extent, reduce interference between cells. The increase of the number of antennas allows for each antenna unit to be made in a smaller size with a lower cost. Using the degree of spatial freedom provided by the large-scale antenna units, the T-TRP 170 and the NT-TRP 172 of each cell can communicate with many EDs 110 in the cell on the same time-frequency resource at the same time, thus greatly increasing the spectral efficiency. A large number of antenna units of the T-TRP 170 and/or the NT-TRP 172 also enable each user to have better spatial directivity for uplink and downlink transmission, so that the transmitting power of the T-TRP 170 and/or the NT-TRP 172 and an ED 110 is reduced and the power efficiency is correspondingly increased. When the antenna number of the T-TRP 170 and/or the NT-TRP 172 is sufficiently large, random channels between each ED 110 and the T-TRP 170 and/or the NT-TRP 172 can approach orthogonality such that interference between cells and users and the effect of noise can be reduced. The plurality of advantages described hereinbefore enable large-scale MIMO to have a magnificent application prospect.

A MIMO system may include a receiver connected to a receive (Rx) antenna, a transmitter connected to transmit (Tx) antenna and a signal processor connected to the transmitter and the receiver. Each of the Rx antenna and the Tx antenna may include a plurality of antennas. For instance, the Rx antenna may have a uniform linear array (ULA) antenna, in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system include: a panel; and a beam.

A beam may be formed by performing amplitude and/or phase weighting on data transmitted or received by at least one antenna port. A beam may be constructed in analog (RF) domain by phase shifters, in digital domain (baseband) through precoding or in a hybrid analog/digital domain. A beam may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. Beam information may include a beam identifier, or an antenna port(s) identifier, or a channel state information reference signal (CSI-RS) resource identifier, or a SSB resource identifier, or a sounding reference signal (SRS) resource identifier, or other reference signal resource identifier.

A sensing system may be used to help gather UE pose information, including the location of the UE in a global coordinate system, the speed and direction of movement (i.e., the velocity vector) of the UE in the global coordinate system, orientation information for the UE and information about the wireless environment in which the UE is located. “Location” is also known as “position” and these two terms may be used interchangeably herein.

Aspects of the present application attempt to address the known lack of adaptability to UE mobility.

Aspects of the present application relate to sensing-based, mobility-aware waveform adaptation. A T-TRP 170 may estimate a velocity vector for a UE 110. The velocity vector estimate may be based on measurements made at the UE 110 and fed back to the T-TRP 170 or based on measurements made at other devices in the environment and provided to the T-TRP 170. The T-TRP 170 may, based on the estimate of the velocity vector, obtain a Doppler variable estimate for signal paths between the T-TRP 170 and the UE 110. Helpful to the task of obtaining the Doppler variable estimate may be information regarding angles of arrival at the UE 110 for signals that follow the signal paths. Such angle of arrival information may be received from the UE 110 or determined based on UE position information. The T-TRP 170 may then adapt a to-be-transmitted waveform based on the Doppler variable estimate for the signal paths and then transmit the adapted waveform. Occasionally, the T-TRP 170 may obtain updates to parameters that describe the location and mobility of the UE 110. On the basis of the updates, the T-TRP 170 may update the waveform adaptation.

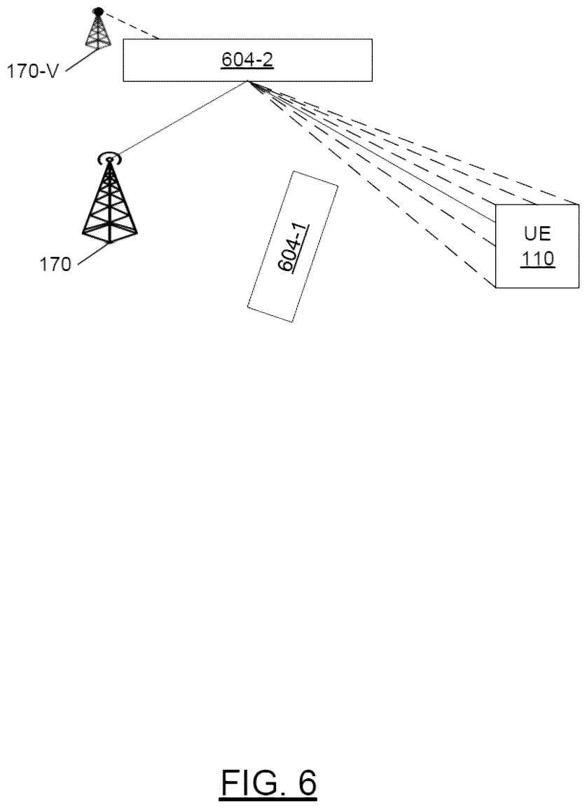

In an environment 600 illustrated in FIG. 6, a T-TRP 170 is to communicate with a UE 110. As illustrated in FIG. 6, the environment 600 includes obstacles 604-1, 604-2. Unfortunately, one of the obstacles 604-1 may be seen to act as a blockage. The blockage 604-1 may be shown to prevent signals from the T-TRP 170 from taking a direct, line-of-sight path to the UE 110. Fortunately, the other one of the obstacles 604-2 may be seen to act as a reflector. Signals from the T-TRP 170 traverse a path to the UE 110 that includes a reflection off the reflector 604-2. The reflector 604-2 may not be entirely “smooth” in an RF sense. A solid line is illustrated in FIG. 6 for an idealized path from the T-TRP 170 to the UE 110. Additional, dashed lines are included in FIG. 6 to represent scattering of the incident signal from the T-TRP 170 toward the UE 110. From the perspective of the UE 110, signals received from the T-TRP 170 after reflecting off the reflector 604-2, and following the path represented as the solid line, appear to have emanated from a virtual TRP 170-V. While a signal that follows a single path from the T-TRP 170 to the UE 110 (e.g., the solid line in FIG. 6) may be associated with a straightforward value for a Doppler shift, the dashed lines may be seen as more representative of real world scenarios. Such real world scenarios may be associated with a distribution of a plurality of values for Doppler shift. Accordingly, Doppler shift may be described as a random variable (“a Doppler variable”) that may be measured to have a probability distribution with a mean (Doppler shift) and a deviation (Doppler spread).

Other reflectors (not shown) may allow for signals from the T-TRP 170 to reach the UE 110 over paths that are distinct from the path illustrated in FIG. 6. The UE 110 may distinguish the paths taken to reach the UE 110 by the Angle-of-Arrival (AoA) of the signals from the T-TRP 170.

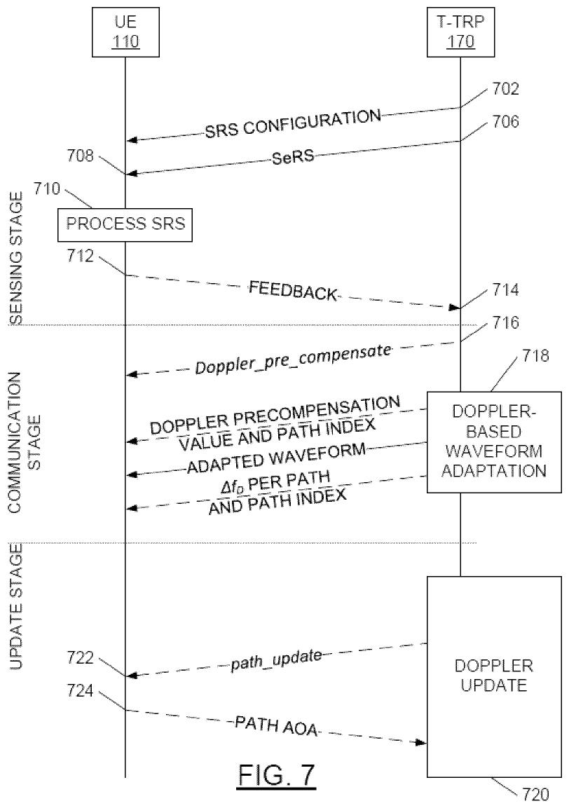

Aspects of the present application relate to a Doppler variable compensation method with three stages: a sensing stage; a communication stage; and an update stage. FIG. 7 illustrates a signal flow diagram for an exchange of signals between a T-TRP 170 and a UE 110 during Doppler variable compensation.

To prepare for the sensing stage, the T-TRP 170 may transmit (step 702), to the UE 110, an indication of a configuration for a to-be-transmitted sensing reference signal (SeRS). In the sensing stage, the T-TRP 170 may transmit (step 706) a sensing reference signal according to the indicated configuration. The configuration may include the details of the sensing reference signal, including the time/frequency resources, waveform type, details of the waveform configuration including numerology and a mapping function to be used when generating a time domain signal on the basis of a sensing profile ID. By receiving and processing echoes of the sensing reference signal, the T-TRP 170 may obtain location information for reflectors and scatterers in an environment of interest, such as the blockage 604-1 and the reflector 604-2.

Additionally, the UE 110 may receive (step 708) the sensing reference signal. The UE 110 may process (step 710) the received sensing reference signal to obtain measurements. The processing (step 710) may allow the UE 110 to obtain multi-path measurement parameters for each dominant path among a plurality of dominant paths. The multi-path measurement parameters for an (th path may include an AoA, a delay, a Doppler variable estimate, fp,l, and a pathloss. The UE 110 may transmit (step 712) feedback to the T-TRP 170. The feedback may include some or all of the multi-path measurement parameters obtained by processing (step 710) the measurements. The feedback may also include pose information of the UE 110, where pose information includes position and velocity vector.

To prepare the multi-path measurement parameters for transmission as feedback, the UE 110 may map the multi-path measurement parameters into a beam-frequency-Doppler domain. Such mapping may be accomplished by quantizing each of the multi-path measurement parameters into a three-dimensional (3D) codeword, H(Nₜ), in a 3D codebook. The dimensions of the codebook may include a transmit beam dimension, a delay dimension and a Doppler variable dimension. A generic 3D codeword, H(Nₜ), may be represented as:

$$H ( {N}_{t} ) = {\sum }_{s , f , d} {a}_{s , f , d} \vec{s} ⊗ \vec{τ} ⊗ \vec{{f}_{D}}$$

where a transmission beam direction is represented by [symbol] , a delay is represented by [symbol] and Doppler variable is represented by [symbol] . Upon completion of the quantizing of the multi-path measurement parameters, the UE 110 may transmit, to the T-TRP 170, feedback. The feedback may include all of the 3D codewords, a subset of the 3D codewords or an indication of the 3D codewords. An indication of a 3D codewords may, for example, be an index to a codeword entry in a table of codewords.

Upon receiving (step 714) the feedback, the T-TRP 170 may obtain a position for the UE 110 and a velocity vector for the UE 110. Additionally, the T-TRP 170 may determine channel state information for use in the communication stage. The position for the UE 110 and the velocity vector for the UE 110 may be used, by the T-TRP 170, when updating per-path Doppler variable information (step 720, explained hereinafter). In some aspects of the present application, the velocity vector for the UE 110 may be measured by sensors that are internal to the UE 110. Accordingly, with regard to the velocity vector, the UE 110 need not perform any measurements on the sensing reference signal. Instead, the velocity vector included in the feedback transmitted in step 712 may be a velocity vector obtained, by the UE 110, based on measurements made by the internal sensors. In this case, the T-TRP 170 may adjust the velocity vector fed back from the UE 110, which might be based on a local coordinate system for the UE 110, to obtain a velocity vector in the global coordinate system.

In the communication stage, the T-TRP 170 may use the feedback, including a Doppler variable estimate for the l^{th} path, f_{D,l}, to perform (step 718) waveform adaptation. That is, the T-TRP 170 may perform Doppler pre-compensation on a scheduled transmission of time-domain waveform samples, sₙ. Doppler pre-compensated time-domain waveform samples, xₙ, may be obtained using xₙ=sₙe^{-j2πnf}^{_{D,l}}^{t}^{ₛ}, where tₛ denotes a sampling time. The T-TRP 170 may then transmit a signal formed by the Doppler pre-compensated time-domain waveform samples, xₙ.

In some aspects of the present application, no Doppler pre-compensation is performed and, instead, a Doppler post-compensation is expected to be performed at the UE 110. In a post-compensation scenario, the UE 110 may multiply received waveform samples by e^{-j2πnf}^{_{D,l}}^{t}^{ₛ}.

In either the pre-compensation case or the post-compensation case, the T-TRP 170 may, optionally, transmit (step 716), to the UE 110, a binary Doppler_pre_compensate indicator to, thereby, indicate, to the UE 110, whether a post-compensation is to be performed or not.

As part of performing (step 718) waveform adaptation, the T-TRP 170 may optionally transmit, to the UE 110, an indication of the Doppler pre-compensation value associated with each path index.

As part of performing (step 718) waveform adaptation, the T-TRP 170 may optionally transmit, to the UE 110, an indication of a change in the Doppler pre-compensation value associated with each path index.

In the update stage, the T-TRP 170 may make use of information that has been obtained, in the sensing stage, in effort to update/refine (step 720) the Doppler variable estimate for each dominant path. As discussed hereinbefore, the information that has been obtained may include information about the position of the UE 110, information about a velocity vector associated with the UE 110 and information about the environment (e.g., the RF map).

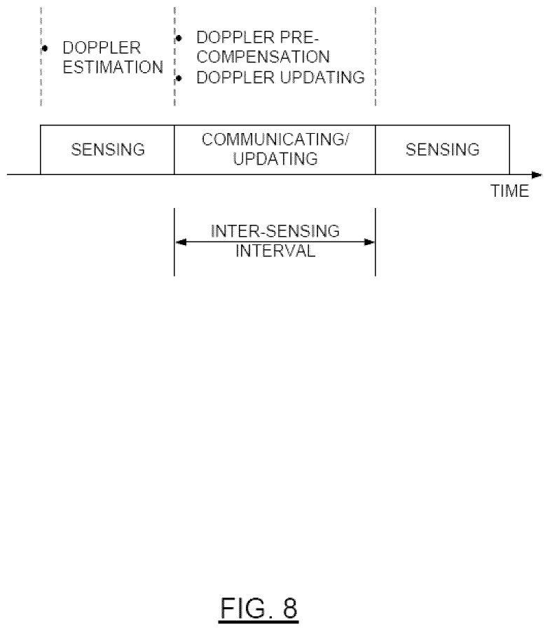

The update (step 720) may be carried out during an interval between two consecutive sensing stages. FIG. 8 illustrates a time line with two consecutive sensing stages interposed by communicating and updating. The time between two consecutive sensing stages may be called an inter-sensing interval.

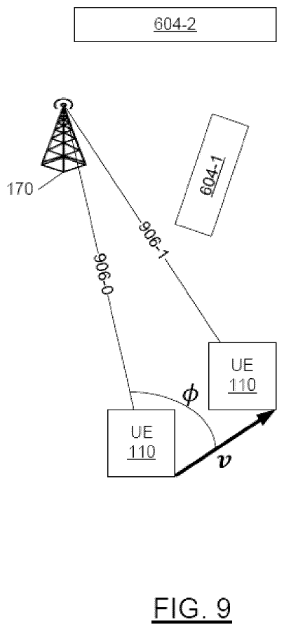

In one scenario, illustrated in FIG. 9, a subsequent path 906-1, at a subsequent time, t₁, may be considered to be an intact version of an initial path 906-0, at an initial time, t₀. The T-TRP 170 at the origin of the initial path 906-0 is the same as the T-TRP 170 at the origin of the subsequent path 906-1. It may be understood that an initial Doppler variable estimate, f_{D0}, has been determined for the initial path 906-0. Despite the path remaining intact, the movement of the UE 110 provides incentive for updating the Doppler variable estimate.

Rather than carry out the same steps that were carried out to estimate the initial Doppler variable estimate, f_{D0}, a lesser effort may be put into to determining an amount, Δf_{D}, by which to correct the initial Doppler variable estimate, f_{D0}, to obtain a subsequent Doppler variable estimate, f_{D1}=f_{D0}+Δf_{D}. In particular, the following relationship may be used to determine the amount, Δf_{D}, by which to correct the initial Doppler variable estimate, f_{D0}:

$$Δ {f}_{D} = {f}_{D 0} \frac{v Δ t {sin}^{2} ( ϕ )}{d}$$

where v denotes the speed of the UE 110 (i.e., the magnitude of the velocity vector, v), Δt denotes an elapsed time between the initial time, t₀, and the subsequent time, t₁, d denotes the path distance (for the initial path 906-0) and ϕ denotes an angle between the initial path AoA and an angle associated with the UE velocity vector, v.

Upon determining the amount, Δf_{D}, by which to correct the initial Doppler variable estimate, f_{D0}, the T-TRP 170 may obtain and transmit (step 718) a new adapted waveform by using the new Doppler variable estimate, f_{D1}. Additionally, the indicate the change, Δf_{D}, to the UE 110, thereby allowing the UE 110 to anticipate the new adapted waveform.

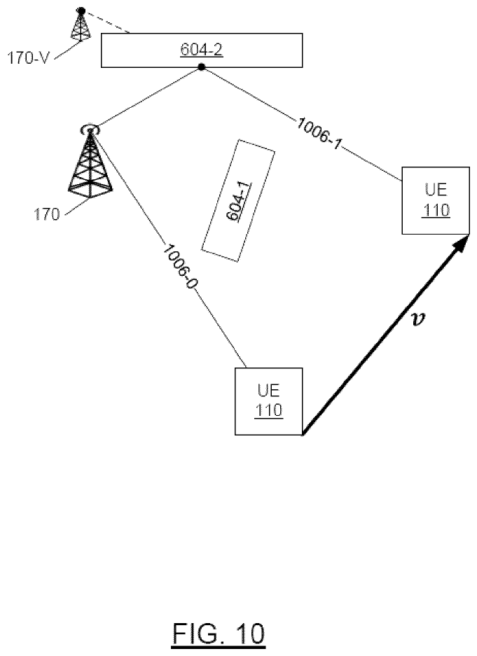

In another scenario, illustrated in FIG. 10, the movement of the UE 110 is such that a subsequent path 1006-1, at a subsequent time, t₁, no longer represents an intact version of an initial path 1006-0, at an initial time, t₀. The T-TRP 170 at the origin of the initial path 1006-0 is distinct from the virtual TRP 170-V at the origin of the subsequent path 1006-1. It may be understood that an initial Doppler variable estimate, f_{D0}, has been determined for the initial path 1006-0. The movement of the UE 110 provides incentive for updating the Doppler variable estimate.

The T-TRP 170 may obtain a subsequent location vector, p₁, of the UE 110 through the use of an initial location vector, p₀, the velocity vector, v, and the elapsed time, Δt=t₁−t₀. That is:

$${p}_{1} = {p}_{0} + v Δ t .$$

Upon obtaining the subsequent location vector, p₁, the T-TRP 170 may determine a plurality of paths to the UE 110 that are dominant based on the position of the UE 110, the environment map and AoA information received (step 714) in the feedback from the UE 110. In some aspects of the present application, the T-TRP 170 may transmit, to the UE 110, a path_update indicator as part of the Doppler update (step 720). Responsive to receiving (step 722) the path_update indicator, the UE 110 may obtain an updated AoA estimate by performing an AoA estimation procedure. The UE 110 may then transmit (step 724) an indication of the updated AoA estimate to the T-TRP 170. The T-TRP 170 may determine a new Doppler variable estimate based on the velocity vector, v, associated with the UE 110 and the received updated AoA estimate. In some embodiments, instead of receiving AoA information from the UE 110, the T-TRP may obtain AoA information based on information stored at the T-TRP 170. Indeed, the information stored at the T-TRP 170 may include an environment map and a look-up table. In view of a plurality of potential UE positions in the environment and a corresponding plurality of visible virtual TRPs for each potential UE position, the look-up table may provide a mapping between UE position and AoA information.

In a case wherein a main reflector for a new path is moving, a Doppler pre-compensation may be determined, by the T-TRP 170, using a two-step procedure. Consider, for example, that the reflector 604-2 in FIG. 10 is moving. In a first step, the T-TRP 170 may project the movement of the virtual TRP 170-V, corresponding to the reflector 604-2, along a line defined by the AoA estimate. In a second step, the T-TRP 170 may determine a relative Doppler variable estimate on the basis of projected movement of the UE 110 and the projected movement of the virtual TRP 170-V.

Notably, in both scenarios discussed hereinbefore, it is assumed that the velocity vector associated with the UE 110 does not change in the inter-sensing interval (see FIG. 8).

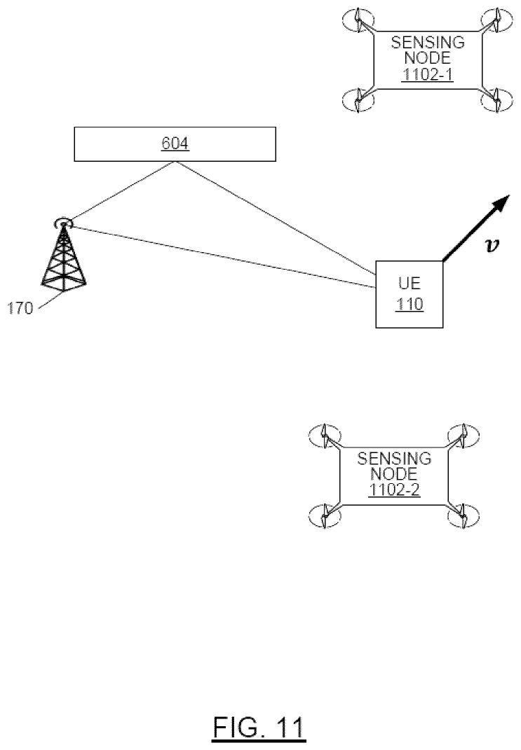

In aspects of the present application, Doppler variable estimation and compensation may be performed with little or no involvement of the UE 110. FIG. 11 illustrates an environment including a T-TRP 170, a UE 110, an obstacle 604 and two sensing nodes 1102-1, 1102-2. The pose (including position, p, and velocity vector, v) of the UE 110 may be estimated by the sensing nodes 1102-1, 1102-2. It is expected that the sensing nodes 1102-1, 1102-2 have been assigned/configured, by the T-TRP 170, to carry out such estimating.

This approach to sensing may be called “cooperative sensing.” An initial pose of the UE 110 may be represented by an original position estimate vector, p₀, and a velocity vector, v. Sensing may be performed, by the sensing nodes 1102-1, 1102-2, with a periodicity that has been defined/configured by the T-TRP 170.

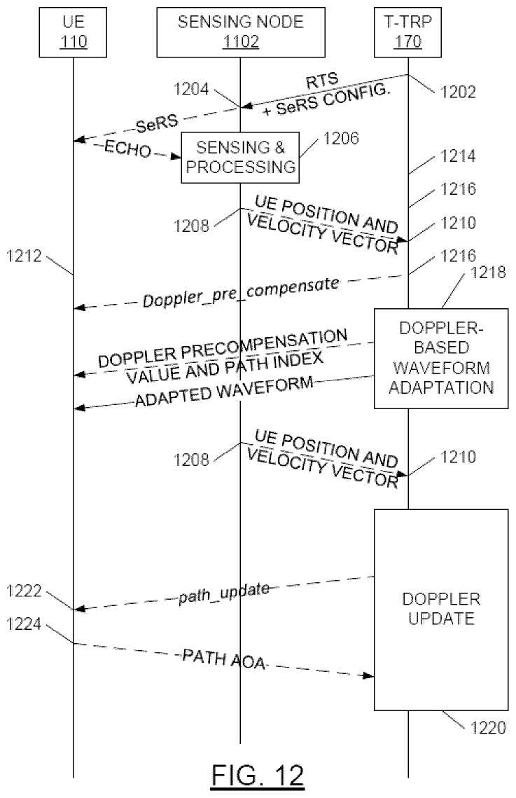

FIG. 12 illustrates a signal flow diagram for an exchange of signals between a T-TRP 170, a sensing node 1102 and a UE 110.

Initially, the T-TRP 170 may transmit (step 1202), to the sensing node 1102, a request-to-sense (RTS) instruction and may transmit (step 1202), together with the RTS instruction, an indication of a configuration for a to-be-transmitted sensing reference signal (SeRS). This indication of a configuration may also include the approximate position of the UE 110 thereby allowing the sensing node 1102 to adjust the transmission of the sensing reference signal to point toward the UE 110 and to adjust the transmit power of the sensing reference signal. In some embodiments, the configuration may include an initial direction in which to point the sensing reference signal. The initial direction in which to point the sensing reference signal may be obtained, by the T-TRP 170, based on the knowledge of an approximate position for the sensing node 1102 and an approximate position for the UE 110. The configuration may also include the details of the sensing reference signal, including the time/frequency resources, waveform type, details of the waveform configuration including numerology and a mapping function to be used when generating a time domain signal on the basis of a sensing profile ID. In some other embodiment, the configuration may contain a sensing ID of the to-be-sensed UE 110, wherein the sensing ID can be different from an ID that is associated with the UE 110 for identifying the UE 110 in a data communication context. Some of these configurations may be dynamic, including the direction of sensing and UE sensing ID and, hence, may be communicated to the sensing node 1102 through Li signaling, including DCI. Some other configurations may be semi-static, including the waveform parameters like the mapping function, and may be communicated to the sensing node 1102 through higher layer signaling, like RRC and MAC-CE. The sensing node 1102 subsequently transmits (step 1204) a sensing reference signal with the indicated configuration. Upon receiving echoes of the sensing reference signal from the UE 110, the sensing node 1102 may process (step 1206) the received echoes to determine a position vector, p₀, and a velocity vector, v, to associate with the UE 110. The velocity vector may be expanded to illustrate component parts, v=(vₓ, v_{y}, v_{z}), wherein vₓ denotes the UE velocity over the x-axis, v_{y} denotes the UE velocity over the y-axis and v_{z} denotes the UE velocity over the z-axis. The position vector may be expanded, to illustrate component parts, in a similar manner. In some embodiments, the position vector and the velocity vector may be expressed in polar coordinates, e.g., the velocity vector may be defined as v=(|v|, ϕᵥ, θᵥ), where |v| denotes the scalar velocity magnitude, ϕᵥ denotes the azimuth angle and θᵥ denotes zenith angle of the velocity vector. The position vector may be expanded, to illustrate polar coordinate parts, in a similar manner. In some embodiments, the echo signal, received by the sensing node 1102, contains information about the UE 110. The information about the UE 110 may enable the sensing node 1102 to distinguish an echo signal corresponding to UE 110 from an echo signal from other UEs or other objects in the environment. The sensing node 1102 may then transmit (step 1208), to the T-TRP 170, indications of the position vector and the velocity vector. The feedback information from sensing node 1102 to the T-TRP 170 (step 1208) may include the identification of the particular UE 110, so that the T-TRP 170 can associate these measurements (p₀, v) to the particular UE 110. In some embodiments, the feedback information may comprise some indications of the position vector and velocity vector. A non-limiting example may include quantizing the position and velocity vectors given a quantization error indicated in the configuration indication transmitted (step 1202) by the T-TRP 170 to the sensing node 1102.

Upon receipt (step 1210) of the indications of the position vector and the velocity vector, the T-TRP 170 may perform (step 1218) waveform adaptation. That is, the T-TRP 170 may perform Doppler pre-compensation on a scheduled transmission of time-domain waveform samples, sₙ. In particular, the T-TRP 170 may use the indications of the position vector and the velocity vector to determine an estimate, f_{D,l}, of a Doppler variable for the l^{th} signal path between the T-TRP 170 and the UE 110. In some embodiments, the T-TRP may obtain AoA information based on information stored at the T-TRP 170. As discussed hereinbefore, the information stored at the T-TRP 170 may include an environment map and a look-up table. In view of a plurality of potential UE positions in the environment and a corresponding plurality of visible virtual TRPs for each potential UE position, the look-up table may provide a mapping between UE position and AoA information.

As discussed hereinbefore, Doppler pre-compensated time-domain waveform samples, xₙ, may be obtained using xₙ=sₙe^{-j2πnf}^{_{D,l}}^{t}^{ₛ}, where tₛ denotes a sampling time. In some aspects of the present application, no Doppler pre-compensation is performed and, instead, a Doppler post-compensation is expected to be performed at the UE 110. In either the pre-compensation case or the post-compensation case, the T-TRP 170 may, optionally, transmit (step 1216), to the UE 110, a binary Doppler_pre_compensate indicator to, thereby, indicate, to the UE 110, whether a post-compensation is to be performed or not.

As part of performing (step 1218) waveform adaptation, the T-TRP 170 may optionally transmit, to the UE 110, an indication of the Doppler pre-compensation value associated with each path index.

In the update stage, the T-TRP 170 may make use of updated information that has been obtained, by the sensing node 1102, in effort to update/refine (step 1220) the Doppler variable estimate for each dominant path. The sensing node 1102 may periodically transmit (step 1208), to the T-TRP 170, indications of an updated position vector and an updated velocity vector.

In an alternative to receiving (step 1210) an updated position vector, the T-TRP 170 may, in the inter-sensing interval (see FIG. 8), obtain a new position, p₁, of the UE 110 at some future time, t₁, using the expression p₁=p₀+vΔt, where Δt=t₁−t₀.

As part of the Doppler update (step 1220), the T-TRP 170 may determine one or more dominant paths based on the new position, p₁, of the UE 110 and the environment map. The determining of the one or more dominant paths may, additionally, be based on AoA information. The AoA information may be determined on the basis of the new position, p₁, of the UE 110 and the position/orientation of the reflector 604. The AoA information may be determined based on a projection of an AoD vector over a reflector plane defined by the reflector 604.

In aspects of the present application, the T-TRP 170 may transmit, to the UE 110, a path_update indicator as part of the Doppler update (step 1220). Upon receiving (step 1222) the path_update indicator, the UE 110 may determine an AoA estimate and transmit (step 1224), to the T-TRP 170, an indication of the AoA estimate. Upon receipt of the indication of the AoA estimate, the T-TRP 170 may re-determine an update to the path Doppler variable estimate based on the UE velocity vector and the AoA estimate.

According to some aspects of the present application, the sensing node 1102 may be configured to periodically determine an updated velocity vector for the UE 110. The sensing nodes 1102 may be configured to transmit (not shown), to the T-TRP 170, any significant changes in the velocity vector for the UE 110.

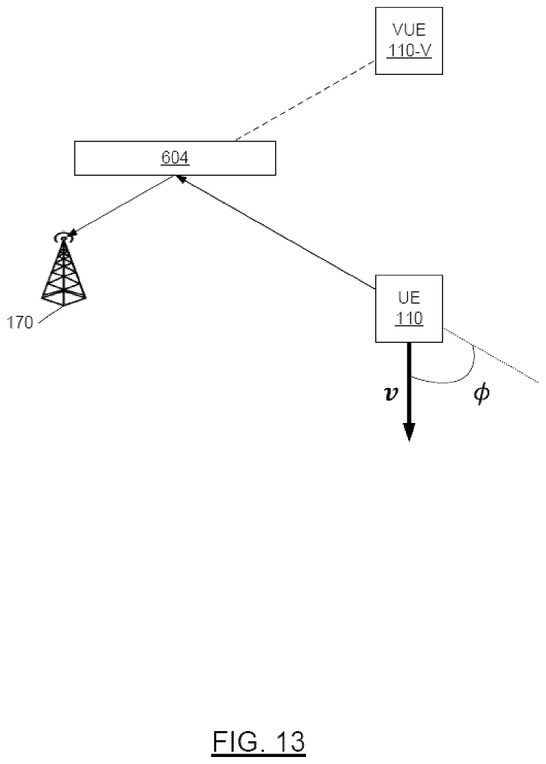

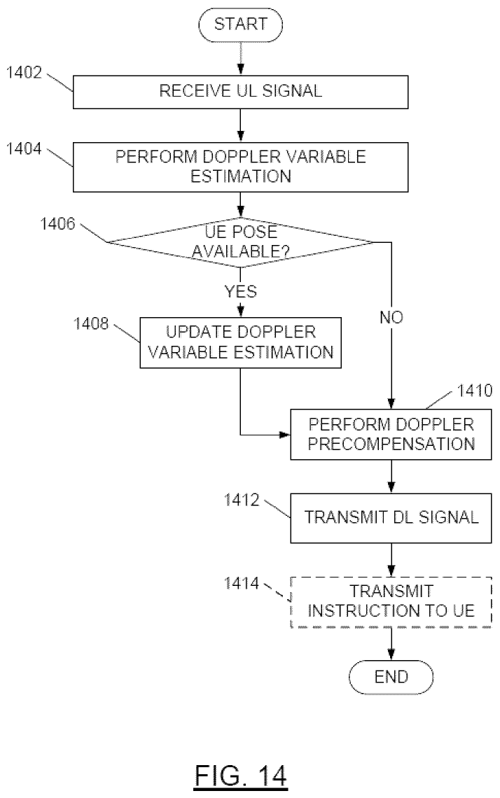

Aspects of the present application relate to a UL-based Doppler variable determination and pre-compensation that acts to exploit reciprocity in channels (DL and UL), in angles (AoA and AoD) and in Doppler variable (f_{D,downlink}=f_{D,uplink}), for a situation illustrated in FIG. 13. Example steps in a method of UL-based Doppler variable determination and pre-compensation are illustrated in FIG. 14.

Initially, the UE 110 transmits a signal. The signal may be a sensing reference signal or a data signal. Upon receiving (step 1402) the signal, the T-TRP 170 may perform (step 1404) Doppler variable estimation on the received signal and may, thereby, obtain a UL Doppler variable estimate, f_{D,uplink}. In the case wherein the received signal is a data signal, it may be understood that the data signal includes a pilot signal. The T-TRP 170 may, first, obtain a rough UL Doppler variable estimate, f_{D,uplink,rough}, and a rough estimate for a channel based on the pilot signal. The T-TRP 170 may, second, decode the data in the data signal and use the decoded data as a sensing pilot to perform fine Doppler variable estimation to, thereby, obtain an updated UL Doppler variable estimate, f_{D,uplink,fine}, that is more accurate than the rough UL Doppler variable estimate, f_{D,uplink,rough}.

Upon determining (step 1406) that the UE pose (position and velocity vector) is available at the T-TRP 170, the T-TRP 170 may perform (step 1408) a Doppler variable update, that is, the T-TRP 170 may obtain a further updated Doppler variable estimate, f_{D,uplink,updated}. The T-TRP 170 may then perform (step 1410) Doppler pre-compensation based on the methods presented hereinbefore. That is, Doppler pre-compensated time-domain waveform samples, xₙ, may be obtained (step 1410) using xₙ=sₙe^{-j2πnf}^{_{D,uplink,updated}}^{t}^{ₛ}.

Upon determining (step 1406) that the UE pose is not available at the T-TRP 170, the T-TRP 170 may then perform (step 1410) Doppler pre-compensation based on the obtained value for the updated UL Doppler variable estimate, f_{D,uplink,fine}, over the received path. That is, Doppler pre-compensated time-domain waveform samples, xₙ, may be obtained (step 1410) using xₙ=sₙe^{-j2πnf}^{_{D,uplink,fine}}^{t}^{ₛ}.

The T-TRP 170 may then transmit (step 1412), to the UE 110, a downlink signal. That is, the T-TRP 170 may then transmit (step 1412), to the UE 110, the Doppler pre-compensated time-domain waveform samples.

The T-TRP 170 may, optionally, transmit (step 1414) a Doppler_Update_Instruction to the UE 110. The T-TRP 170 may, as part of transmitting (step 1412) the Doppler_Update_Instruction, also transmit, to the UE 110, information. The information may include the obtained value for the updated Doppler variable estimate, f_{D,uplink,fine}, and the path distance, d. This information may be shown to allow the UE 110 to determine a change in DL Doppler variable estimate, Δf_{D,downlink}. The determining may be based on information maintained at the UE 110, such as a velocity vector and an AoA. The UE 110 may determine the change in DL Doppler variable estimate, Δf_{D,downlink}, using the following formula:

$$Δ {f}_{D , downlink} = \frac{v Δ t sin ϕ}{d} .$$

Upon determining the change in DL Doppler variable estimate, Δf_{D,downlink}, the UE 110 may perform Doppler post-compensation e^{-j2πnf}^{_{D,downlink}}^{t} over a received DL signal, even though the DL signal has already been pre-compensated (step 1410) by the T-TRP 170.

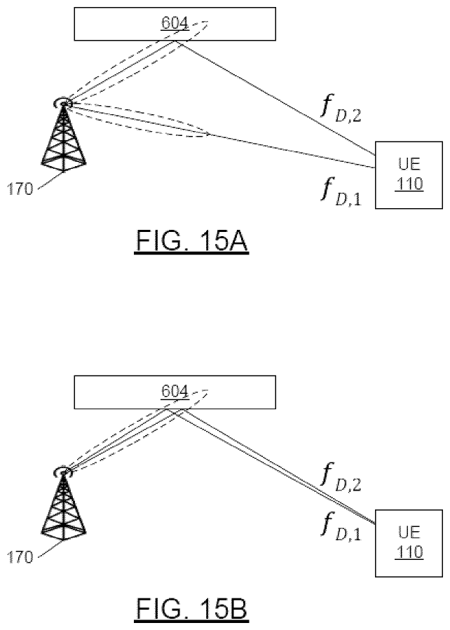

Aspects of the present application relate to Doppler pre-compensation at a transmitter. For a downlink (DL) transmission, the transmitter is the T-TRP 170. FIG. 15A illustrates a scenario wherein the UE 110 receives a signal from the T-TRP 170 over multiple paths. FIG. 15B also illustrates a scenario wherein the UE 110 receives a signal from the T-TRP 170 over multiple paths. One difference between the scenario illustrated in FIG. 15A and the scenario illustrated in FIG. 15B is that the paths in FIG. 15A may be called “separable” and, in contrast, the paths in FIG. 15B may be called “inseparable.” The separable paths of FIG. 15A may be formed through analog/digital beamforming. When the paths are inseparable, the UE 110 and/or the T-TRP 170 are not capable of distinguishing the paths due to limited processing resources or limited resources of the sensing reference signal. A limited number of antennas may be shown to affects separability of paths in an angle domain. A limited bandwidth of the sensing reference signal may be shown to affect separability in a delay domain. The processing bandwidth of the nodes may be shown to affect separability in the delay domain. A limited time duration may be shown to affect separability in a Doppler domain.

In consideration of Doppler compensation for the separable paths of FIG. 15A, aspects of the present application relate to determining separate compensation for each path among the separate paths. It may be assumed that, before any digital/analog beamforming takes place, there are N channels between the T-TRP 170 and the UE 110. The T-TRP 170 may use a beamforming vector for the l^{th} channel, among the N channels. Through the use of the beamforming vector, the T-TRP 170 may aim the l^{th} channel in the l^{th} path direction. Upon obtaining a Doppler variable estimate, f_{D,l}, for the l^{th} path, the T-TRP 170 may pre-compensate the signal transmitted on the l^{th} channel by e^{-j2πnf}^{_{D,l}}^{t}. It is expected that, in the scenario illustrated in FIG. 15A, the UE 110 will experience a time invariant channel over each path.

In view of the inseparable paths of FIG. 15B, an equivalent channel, even after beamforming, is multi-path. In consideration of Doppler compensation, in a first option, the T-TRP 170 may obtain a Doppler shift value estimate, f_{D,mean}, for a “mean” Doppler shift value. The mean Doppler shift value may be defined as the mean of a plurality of Doppler shift values. The T-TRP 170 may then pre-compensate by multiplying waveform time samples by e^{-j2πnf}^{_{D,mean}}^{t}. In consideration of Doppler compensation, in a second option, the T-TRP 170 may obtain a Doppler shift value estimate, f_{D,ave}, for an average path. The Doppler variable estimate, f_{D,ave}, may be determined as the average of the estimated Doppler values for all paths. The T-TRP 170 may then pre-compensate by multiplying waveform time samples by e^{-j2πnf}^{_{D,ave}}^{t}.

In the case of the separable paths of FIG. 15B, the T-TRP 170 may signal, to the UE 110, a value of an estimate of the pre-compensation Doppler variable, f_{D}, a path index that specifies the path for which the pre-compensation is to be performed and a residual Doppler vector for the rest of the paths (if the residual Doppler vectors are greater than a threshold). A residual Doppler vector may be expressed as a vector of differences between the Doppler variable, f_{D}, of the path for which the pre-compensation is to be performed and the Doppler variable, f_{D}, of the paths for which the pre-compensation is not to be performed. Notably, even for separable paths, the T-TRP 170 may decide to use only one Doppler variable, f_{D}, for pre-compensation. The reason may be that, for example, due to analog beamforming, the beam contains all paths and it may be considered to be more convenient to apply a single Doppler variable to all paths.

For an uplink (UL) transmission, the transmitter is the UE 110. Aspects of the present application rely upon an assumption of channel reciprocity for angle and Doppler variable. The UE 110 may obtain, through measurements, a Doppler variable estimate for each path, with the paths distinguished by AoA. The measurements may be based on a projection. The UE 110 may pre-compensate a to-be-transmitted signal on a particular path using the Doppler variable estimate associated with the particular path. In case of multi-path, the UE 110 may use one of the methods presented hereinbefore for pre-compensation using the same signaling mechanism. The T-TRP 170 may transmit, to the UE 110, per-path estimated Doppler variable estimates. The UE 110 may use the per-path Doppler variable estimates for pre-compensation.

It should be appreciated that one or more steps of the embodiment methods provided herein may be performed by corresponding units or modules. For example, data may be transmitted by a transmitting unit or a transmitting module. Data may be received by a receiving unit or a receiving module. Data may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A method, comprising:
obtaining, at a transmitting device, an estimate of a velocity vector for a mobile device;
obtaining, at the transmitting device and based on the estimate of the velocity vector, an estimate of a Doppler variable for a signal path between the transmitting device and the mobile device;
obtaining, at the transmitting device and based on the estimate of the Doppler variable for the signal path, an adapted waveform; and
transmitting, from the transmitting device, a signal according to the adapted waveform.

2. The method of claim 1, wherein obtaining the estimate of the velocity vector comprises obtaining the estimate of the velocity vector based on information received from a sensing device.

3. The method of claim 2, further comprising transmitting, to the sensing device, an indication of a configuration for a sensing reference signal.

4. The method of claim 3, wherein the configuration comprises at least one of:
an indication of an approximate position of the mobile device;
an indication of an initial direction in which to point the sensing reference signal;
an indication of time resources for the sensing reference signal and an indication of frequency resources for the sensing reference signal;
an indication of a waveform type for the sensing reference signal;
an indication of a numerology for the sensing reference signal;
an indication of a mapping function to be used when generating a time domain signal on a basis of a sensing profile identification; or
an indication of a sensing identification of the mobile device, wherein the sensing identification is different from an identification that is associated with the mobile device for identifying the mobile device in a data communication context.

5. The method of claim 1, wherein the velocity vector comprises at least one of:
a plurality of velocity values associated with a corresponding plurality of orthogonal directions in a global coordinate system; or
a scalar velocity magnitude, an azimuth angle and a zenith angle.

6. An apparatus comprising:
at least one processor; and
a non-transitory memory including instructions that, when executed by the at least one processor, cause the apparatus to:
obtain an estimate of a velocity vector for a mobile device;
obtain, based on the estimate of the velocity vector, an estimate of a Doppler variable for a signal path between the apparatus and the mobile device;
obtain, based on the estimate of the Doppler variable for the signal path, an adapted waveform; and
transmit a signal according to the adapted waveform.

7. The apparatus of claim 6, wherein the instructions to obtain the estimate of the velocity vector comprise instructions to obtain the estimate of the velocity vector based on information received from a sensing device.

8. The apparatus of claim 7, wherein the instructions further cause the apparatus to transmit, to the sensing device, an indication of a configuration for a sensing reference signal.

9. The apparatus of claim 8, wherein the configuration comprises at least one of:
an indication of an approximate position of the mobile device;
an indication of an initial direction in which to point the sensing reference signal;
an indication of time resources for the sensing reference signal and an indication of frequency resources for the sensing reference signal;
an indication of a waveform type for the sensing reference signal;
an indication of a numerology for the sensing reference signal;
an indication of a mapping function to be used when generating a time domain signal on a basis of a sensing profile identification; or
an indication of a sensing identification of the mobile device, wherein the sensing identification is different from an identification that is associated with the mobile device for identifying the mobile device in a data communication context.

10. The apparatus of claim 6, wherein the velocity vector comprises at least one of:
a plurality of velocity values associated with a corresponding plurality of orthogonal directions in a global coordinate system; or
a scalar velocity magnitude, an azimuth angle and a zenith angle.

11. A method, comprising:
receiving, at a mobile device, a sensing reference signal;
processing, at the mobile device, the sensing reference signal, to obtain an estimate of a velocity vector for the mobile device;
transmitting, from the mobile device to a first device, feedback, the feedback including an indication of the estimate of the velocity vector, thereby allowing the first device to:
obtain, based on the estimate of the velocity vector, an estimate of a Doppler variable for a signal path between the first device and the mobile device; and
obtain, based on the estimate of the Doppler variable for the signal path, an adapted waveform; and
receiving, at the mobile device, a signal according to the adapted waveform.

12. The method of claim 11, further comprising:
before receiving the sensing reference signal, receiving an indication of a configuration for the sensing reference signal.

13. The method of claim 12, wherein the configuration comprises at least one of:
an indication of time resources for the sensing reference signal and an indication of frequency resources for the sensing reference signal;
an indication of a waveform type for the sensing reference signal;
an indication of a numerology for the sensing reference signal; or
an indication of a mapping function to be used when generating a time domain signal on a basis of a sensing profile identification.

14. The method of claim 11, further comprising:
receiving, from the first device, an indication of a Doppler pre-compensation value, the Doppler pre-compensation value characterizing the adapted waveform.

15. The method of claim 11, wherein the velocity vector comprises at least one of:
a plurality of velocity values associated with a corresponding plurality of orthogonal directions in a global coordinate system; or
a scalar velocity magnitude, an azimuth angle and a zenith angle.

16. An apparatus comprising:
at least one processor; and
a non-transitory memory including instructions that, when executed by the at least one processor, cause the apparatus to:
receive a sensing reference signal;
process the sensing reference signal to obtain an estimate of a velocity vector for the apparatus;
transmit, to a first device, feedback, the feedback including an indication of the estimate of the velocity vector, thereby allowing the first device to:
obtain, based on the estimate of the velocity vector, an estimate of a Doppler variable for a signal path between the first device and the apparatus; and
obtain, based on the estimate of the Doppler variable for the signal path, an adapted waveform; and
receive a signal according to the adapted waveform.

17. The apparatus of claim 16, wherein the instructions further cause the apparatus to:
before receiving the sensing reference signal, receive an indication of a configuration for the sensing reference signal.

18. The apparatus of claim 17, wherein the configuration comprises at least one of:
an indication of time resources for the sensing reference signal and an indication of frequency resources for the sensing reference signal;
an indication of a waveform type for the sensing reference signal;
an indication of a numerology for the sensing reference signal; or
an indication of a mapping function to be used when generating a time domain signal on a basis of a sensing profile identification.

19. The apparatus of claim 16, wherein the instructions further cause the apparatus to:
receive, from the first device, an indication of a Doppler pre-compensation value, the Doppler pre-compensation value characterizing the adapted waveform.

20. The apparatus of claim 16, wherein the velocity vector comprises at least one of:
a plurality of velocity values associated with a corresponding plurality of orthogonal directions in a global coordinate system; or
a scalar velocity magnitude, an azimuth angle and a zenith angle.
